(19) United States
(12) Patent Application Publication
(10) Pub. No.: US 2018/0052966 A1
(43) Pub. Date: Feb. 22, 2018

(54) Systems And Methods for Optimizing Care For Patients and Residents Based On Interactive Data Processing, Collection, And Report Generation

(71) Applicant: VisibleHand, Inc., Denver, CO (US)

(72) Inventors: Matt J. Morris, Denver, CO (US); Gary L. Haith, Evergreen, CO (US); Vicente Fernandez, Centennial, CO (US); Harvey S. Morris, Tucson, AZ (US)

(73) Assignee: VisibleHand, Inc., Denver, CO (US)

(21) Appl. No.: 15/345,038

(22) Filed: Nov. 7, 2016

Related U.S. Application Data
(60) Provisional application No. 62/377,377, filed on Aug. 19, 2016.
(60) Provisional application No. 62/395,986, filed on Sep. 16, 2016.

(51) Int. Cl. G06F 19/00

(52) U.S. Cl. CPC G06F 19/3418; G06F 19/3425; G06F 19/3431

(57) ABSTRACT

A computer-implemented method for monitoring resident behavior, health, and treatments received, the method being executed by one or more processors and including providing a prioritized list of residents, symptoms, and behaviors to be observed on a mobile computing device. The method further includes receiving from a user at the mobile computing device, a selection of a resident of the list of residents. The method further includes displaying at the mobile computing device, information related to a behavior of interest of the resident. The method further includes receiving from the user an input concerning behavior of the resident at the mobile computing device and displaying a proposed intervention at the mobile computing device.

### CROSS-REFERENCES TO RELATED APPLICATIONS

This Application claims the benefit of Provisional Application No. 62/377,377 filed on Aug. 19, 2016 titled “Systems and Methods for Optimizing Care For Patients Based On Interactive Data Processing, Collection, and Report Generation” and of Provisional Application No. 62/395,986 filed on Sep. 16, 2016 titled “Systems and Methods for Optimizing Care for Patients and Residents Based on Interactive Data Processing, Collection and Report Generation.”

### BACKGROUND

The monitoring of residents in a healthcare setting is valuable tool for customizing and improving the care provided. Resident responses to certain treatments or even ordinarily occurring events (such as meals, outings, sleep, or other commonplace events) may be difficult to track and insights resulting from the tracking may be difficult to apply. Additionally, particular caregivers may need different instructions based on their own predilections in addition to environmental events and resident moods. Although some trends are tracked for residents and patients, it is difficult to provide real time instructions or training based on recent events.

### SUMMARY

In one embodiment, a computer-implemented method for monitoring resident behavior, health, and treatments received, the method being executed by one or more processors and including providing a prioritized list of residents to be observed on a mobile computing device. The method further includes receiving from a user at the mobile computing device, a selection of a resident from the list of residents. The method further includes displaying at the mobile computing device, information related to a behavior of interest to the resident. The method further includes receiving from the user an input concerning behavior of the resident at the mobile computing device and displaying a proposed intervention at the mobile computing device. Alternatively, the proposed intervention is received at the mobile computing device from a remote server. In one alternative, the input concerning the behavior of the resident is sent to the remote server and the proposed intervention is based on the input from the user concerning the behavior of the resident. In another alternative, the proposed intervention is also based on data concerning effectiveness of previous interventions. Alternatively, the prioritized list of residents is provided to the mobile computing device from a remote server, and the remote server prioritizes the prioritized list according to weighted information gain of the behavior of interest to the resident as compared to other information that is collectable from other residents. In one alternative, the method further includes receiving an input concerning the success of intervention administered at the mobile computing device; and transmitting the input concerning the success of intervention to the remote server. Alternatively, the method further includes prior to receiving the input concerning behavior of the resident, receiving a “finish later” indication from the user at the mobile device; and alerting the user at a later time of the need to complete the input concerning behavior of the resident. In one alternative, the method further includes determining at a remote server the information related to the behavior of interest to the resident to be displayed, based on previous data concerning behaviors of interest; and transmitting the behavior of interest to the resident to be displayed to the mobile computing device. Alternatively, the information related to the behavior of interest, includes displaying training information on how to recognize the behavior of interest. In one alternative, the method further includes displaying basic resident characteristics for the resident. In one alternative, the proposed intervention is based on best practices information, determined via analyzing data related to populations of similar residents across different populations. In another embodiment, the best practices information is tailored based on specific characteristics of the resident and patterns of the resident's behavior. Alternatively, the prioritized list of residents is provided to the mobile computing device from a remote server, and the remote server prioritizes the list according to weighted information gain of a missing data items, where the weighted information gain is weighted by an expected impact on suggested interventions and predictions and inversely weighted by an effort needed to gather the missing data item. Optionally, the method further includes providing, to a supervisor, facility information concerning residents that are included in the list of residents and staff; receiving a request to reorder the prioritized list from the supervisor, based on the facility information; and reordering the prioritized list based on the request. Optionally, the method further includes providing, to a supervisor, facility information concerning residents that are included in the list of residents and staff; receiving a request to change the behavior of interest from the supervisor, based on the facility information; and changing the behavior of interest based on the request. Optionally, the method further includes: providing, to a supervisor, facility information concerning residents that are included in the list of residents and staff; receiving a request to provide training information to the user from the supervisor, based on the facility information; providing the training information to the user at the mobile computing device. In one alternative, the facility information includes time to scheduled observations of the residents, observation priority of the residents, last behavior of the residents, last sleeping/awake observation of the residents, next medication time for the residents, next ADL (activities of daily living) need for the residents, acute behavior risk for the residents. Optionally, the supervisor is a human. In one alternative, the supervisor is a human guided by the system. Alternatively, the supervisor is a computer implemented algorithm.

In one embodiment, a non-transitory computer-readable storage device coupled to one or more processors and having instructions stored thereon which, when executed by the one or more processors, cause the one or more processors to perform operations for monitoring resident behavior, health, and treatments received, the operations including providing a prioritized list of residents to be observed on a mobile computing device. The operations further include receiving from a user at the mobile computing device, a selection of a resident of the list of residents; displaying at the mobile computing device, information related to a behavior of interest to the resident. The operations further include receiving from the user an input concerning behavior of the resident at the mobile computing device; and displaying a proposed intervention at the mobile computing device.

In one embodiment, a system includes one or more processors; and a computer-readable storage medium in communication with the one or more processors and having instructions stored thereon which, when executed by the one or more processors, cause the one or more processors to perform operations for monitoring resident behavior, health, and treatments received, the operations include providing a prioritized list of residents to be observed on a mobile computing device. The operations further include receiving from a user at the mobile computing device, a selection of a resident of the list of residents. The operations further include displaying at the mobile computing device, information related to a behavior of interest to the resident. The operations further include receiving from the user an input concerning behavior of the resident at the mobile computing device and displaying a proposed intervention at the mobile computing device. Alternatively, the proposed intervention is received at the mobile computing device from a remote server. In one alternative, the input concerning the behavior of the resident is sent to the remote server and the proposed intervention is based on the input from the user concerning the behavior of the resident. In another alternative, the proposed intervention is also based on data concerning effectiveness of previous interventions. Alternatively, the prioritized list of residents is provided to the mobile computing device from a remote server, and the remote server prioritizes the prioritized list according to weighted information gain of the behavior of interest to the resident as compared to other information that is collectable from other residents. In one alternative, the operations further include receiving an input concerning the success of intervention administered at the mobile computing device; and transmitting the input concerning the success of intervention to the remote server. Alternatively, the operations further include prior to receiving the input concerning behavior of the resident, receiving a “finish later” indication from the user at the mobile device; and altering the user at a later time of the need to complete the input concerning behavior of the resident. In one alternative, the operations further include determining at a remote server the information related to the behavior of interest of the resident to be displayed, based on previous data concerning behaviors of interest; and transmitting the behavior of interest to the resident to be displayed to the mobile computing device. Alternatively, the information related to the behavior of interest, includes displaying training information on how to recognize the behavior of interest. In one alternative, the operations further include displaying basic resident characteristics for the resident. In one alternative, the proposed intervention is based on best practices information, determined via analyzing data related to populations of similar residents across different populations. In another embodiment, the best practices information is tailored based on specific patterns of the resident. Alternatively, the prioritized list of residents is provided to the mobile computing device from a remote server, and the remote server prioritizes the list according to weighted information gain of a missing data item, where the weighted information gain is weighted by an expected impact on suggested interventions and predictions and inversely weighted by an effort needed to gather the missing data item. Optionally, the operations further includes providing, to a supervisor, facility information concerning residents that are included in the list of residents and staff; receiving a request to reorder the prioritized list from the supervisor, based on the facility information; and reordering the prioritized list based on the request. Optionally, the operations further include providing, to a supervisor, facility information concerning residents that are included in the list of residents and staff; receiving a request to change the behavior of interest from the supervisor, based on the facility information; and changing the behavior of interest based on the request. Optionally, the operations further include providing, to a supervisor, facility information concerning residents that are included in the list of residents and staff; receiving a request to provide training information to the user from the supervisor, based on the facility information; providing the training information to the user at the mobile computing device. In one alternative, the facility information includes time to scheduled observations of the residents, observation priority of the residents, last behavior of the residents, last sleeping/awake observation of the residents, next medication time for the residents, next ADL (activities of daily living) need for the residents, acute behavior risk for the residents. Optionally, the supervisor is a human. Alternatively, the supervisor is a computer implemented algorithm. In one alternative, the supervisor is a human guided by the system.

### BRIEF DESCRIPTION OF THE FIGURES

FIG. 1a shows an exemplary system diagram focused on the hardware used to implement an exemplary system;

FIG. 1b shows a conceptual representation of one embodiment of an exemplary system;

FIG. 2a shows an interface/menu of an embodiment of a data collection system;

FIG. 2b shows another view of an interface/menu of an embodiment of a data collection system, highlighting the list of those for who observations are to be completed;

FIG. 3 shows another view of an interface/menu of an embodiment of a data collection system, highlighting instructions on how to detect a behavior;

FIG. 4 shows another view of an interface/menu of an embodiment of a data collection system, highlighting instructions on how to detect another behavior;

FIG. 5 shows another view of an interface/menu of an embodiment of a data collection system, highlighting basic information on a resident;

FIG. 6 shows another view of an interface/menu of an embodiment of a data collection system, highlighting recent activity for the resident;

FIG. 7a shows another view of an interface/menu of an embodiment of a data collection system, highlighting an interface for recording behavior;

FIG. 7b shows another view of an interface/menu of an embodiment of a data collection system, highlighting another interface for recording behavior;

FIG. 8 shows another view of an interface/menu of an embodiment of a data collection system, highlighting yet another interface for recording behavior;

FIG. 9 shows another view of an interface/menu of an embodiment of a data collection system, highlighting an interface for recording location and internal triggers;

FIG. 10 shows another view of an interface/menu of an embodiment of a data collection system, highlighting an interface for recording interventions used;

FIG. 11a shows another view of an interface/menu of an embodiment of a data collection system, highlighting another interface for recording interventions used;

FIG. 11b shows another view of an interface/menu of an embodiment of a data collection system, highlighting yet another interface for recording interventions used;

FIG. 12 shows another view of an interface/menu of an embodiment of a data collection system, highlighting an interface for recording notes on interventions;

FIG. 13 shows another view of an interface/menu of an embodiment of a data collection system, highlighting another interface for an absence of behavioral issues; and

FIG. 14 shows another view of an interface/menu of an embodiment of a data collection system, highlighting an interface for recording location and notes.

### DETAILED DESCRIPTION

Certain terminology is used herein for convenience only and is not to be taken as a limitation on the embodiments of the systems and methods for optimizing care for patients and residents based on interactive data processing, collection, and report generation. In the drawings, the same reference letters are employed for designating the same elements throughout the several figures.

In many embodiments, a method for analyzing and influencing the interactions between non-stationary learning agents is provided. The prototypical agents are the “resident” (or “patient”) who has patterns of behavior based on mental state and context and the “staff” (or “caregiver”) who uses patterns of interventions to try to beneficially influence the future behavior of the resident. In addition to the typical caregiver or staff, there many times is a staff person who is a manager of the caregivers, such as a “supervisor” or “clinician.” Typically, it is such a supervisor who interacts with embodiments of the system in order to provide guidance and feedback to the caregiver. The supervisor may be located at the facility or may be remote, since the activities may be monitored through the system. The The staff's choice of intervention depends on the residents' time series of behaviors, their experience, training and other factors. Likewise the resident's future behaviors are influenced by the chosen behavioral, environmental and pharmaceutical interventions. Embodiments of the systems and methods provided herein uses algorithms to identify temporal and characteristic based patterns in order to profile both the resident and staff at each point in time and identify and suggest the interventions with the highest likelihood of success for a given resident at a given time to maximize resident and staff satisfaction (and potentially healthcare reimbursement). Embodiments of the systems and method also help supervisory staff in understanding both the current situation and the trends in the staff behavior so as to prioritize re-training, rewards and identification of “role-model” staff. The algorithms support both analysis of current patterns of behavior, and the evolution of staff behavior in response to training and resident behaviors in response to interventions. These algorithms, systems, and methods are generally implemented in an application based system that executes on mobile devices and centralized servers.

Embodiments of systems and methods for optimizing care for residents and residents based on interactive data processing, collection, and report generation include a centrally based data processing, communication, and collection system (hereinafter the systems or methods may be referred to as care optimization systems or care optimization methods). Over time, embodiments of care optimization systems collect data concerning various care events. These care events may be input to the system via mobile and static computing devices such as smart phones, tablets, laptop computers, desktop computers, kiosks, etc. These events may include various care events such as the need to administer medication, the need for physical intervention, the general well-being of the resident (including but not limited to sleep patterns, eating patterns, grooming patterns, lucidity, problematic behaviors, and numerous other metrics), and even behavior reporting concerning resident wellbeing, such as “is the resident agitated”, “what resident's memory level”, “what is resident's mental clarity level”, etc. Additionally, the system may track all treatment or care given to the resident, such as medicines, physical intervention, and even basic care (such as sleep schedules, what food is provided at what times, etc.) as well as social and environmental stimulus provided (such as recreational activities, visiting hours, or outings, etc.). Additional data that may be collected is described herein related to the differentiating features described below.

Embodiments of systems and method may collect this data over time. The mobile device utilized by the user may automatically provide a questionnaire to the caregiver that is triggered upon certain events or may be accessed by the caregiver through a menu drive or other type of interface. One common event that may trigger the need to record observations is the prioritized list provided to caregivers. In many embodiments, events used to trigger the questionnaire may include the location or proximity of a mobile device (which may be determined via RFID, Near Field Communication, Bluetooth communications, GPS, wireless network proximity, or other means) as well as the scanning of a QR code, bar code, or other indicator, or the input of a code by the user. The questionnaire provided may be custom to each resident, standardized to particular residents, or standard to all residents, and additionally may evolve over time.

Based on this data collection the system may recognize trends in resident health and generate and make recommendations for care. For example, these recommendations may be in report form for residents, or may be generated and sent to the mobile device utilized by the care giver at the time of care. As with the questionnaire part of the system, these recommendations for care may be automatically triggered according to the location or proximity of the device as well as upon the entering of a code, scanning of a code, or selection of a resident through an interface. Behavioral plans may be triggered based on the staff, the resident/resident, the time of day, how recently certain events took place, as well as many other factors.

Additionally, the wellbeing of caregivers may be similarly tracked and correlated in relation to the resident care provided and exemplary caregivers identified. Feedback may be given to staff concerning optimal care techniques. Additionally, the results from the application of medicine may be used to guide future applications of medicine and/or changes in the application regimens.

In an exemplary embodiment, a system provides first for a very efficient data collection system. Such a system is necessary because in a resident or resident environment, typically caregivers are relatively untrained, very busy and do not naturally enter or have the time to enter data concerning resident treatment and behavior.

Typically, the system takes the form of an application resident on a mobile computing device and a centralized system that communicates with the mobile computing device. Those of ordinary skill in the art will appreciate types of systems that may fit this paradigm, including but not limited to using applications that execute in the android or iOS on mobile devices such as smart phones and tablets. The system may further include a centralized server that communicates via a mobile network (such as GSM, LTE, WiFi or other network) with the mobile device.

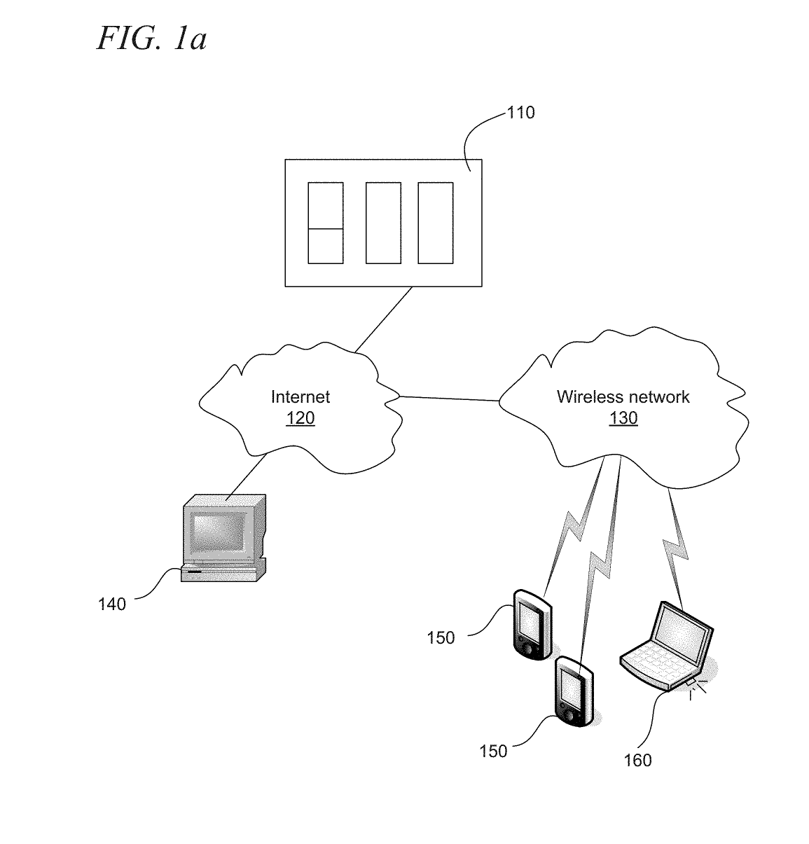

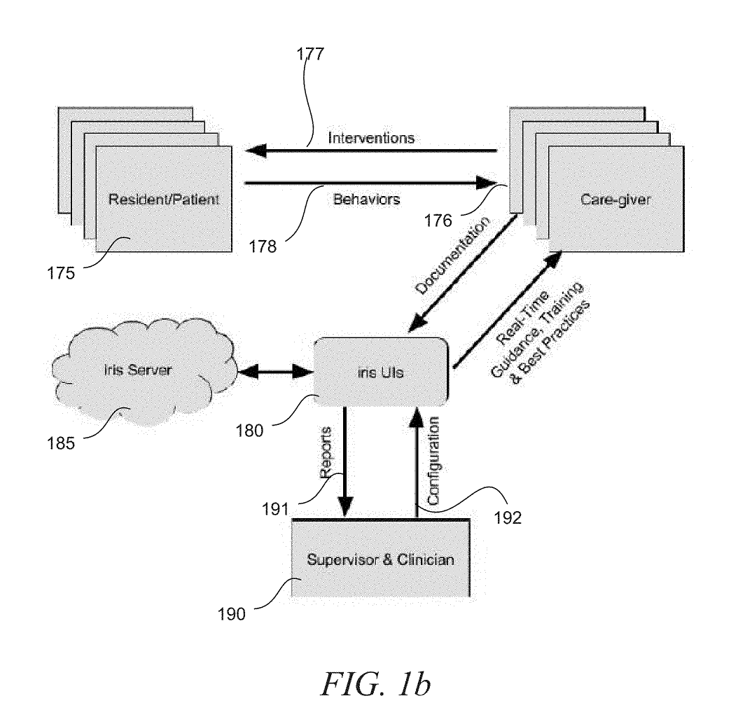

FIG. 1a shows an exemplary system diagram focused on the hardware used to implement an exemplary system. Typically, an application runs on mobile phone or tablet 150. Mobile phone communicates via wireless network 130 and internet 120 with centralized server 110. Data concerning observations of residents or residents are stored and analyzed at centralized server 110 and communicated via internet 120 and wireless 130 to mobile devices 150 and computer 140 or laptop 160. This is merely an exemplary structure and other configurations may be utilized.

FIG. 1b shows a conceptual representation of one embodiment of an exemplary system. Residents 175 typically interact with caregivers 176. Caregivers 176 administer interventions 177 to residents 175 based on resident needs. Caregivers 176 additionally observe behaviors 178. These behaviors may be the basis of the interventions provided. The caregivers 176 utilize embodiments of the systems described herein to document interventions administer and behaviors observed. Caregivers 176 interact with the user interface 180 of the system that is typically implemented on a mobile device. The interfaces described below enable such data collection. At the same time, the system, via the user interface 180 provides instructions and information to the caregivers 176 in the form of real-time guidance, training, and best practices. The user interface 180 operating on a mobile device (typically) communicates with a remote server 185 that provides the data processing that enables the suggestion of intervention, etc. Additionally, supervisors and clinicians 190 may interact with user interface 180 and generate reports 191 of the resident and caregiver behaviors as well as configure 192 the operation of the system.

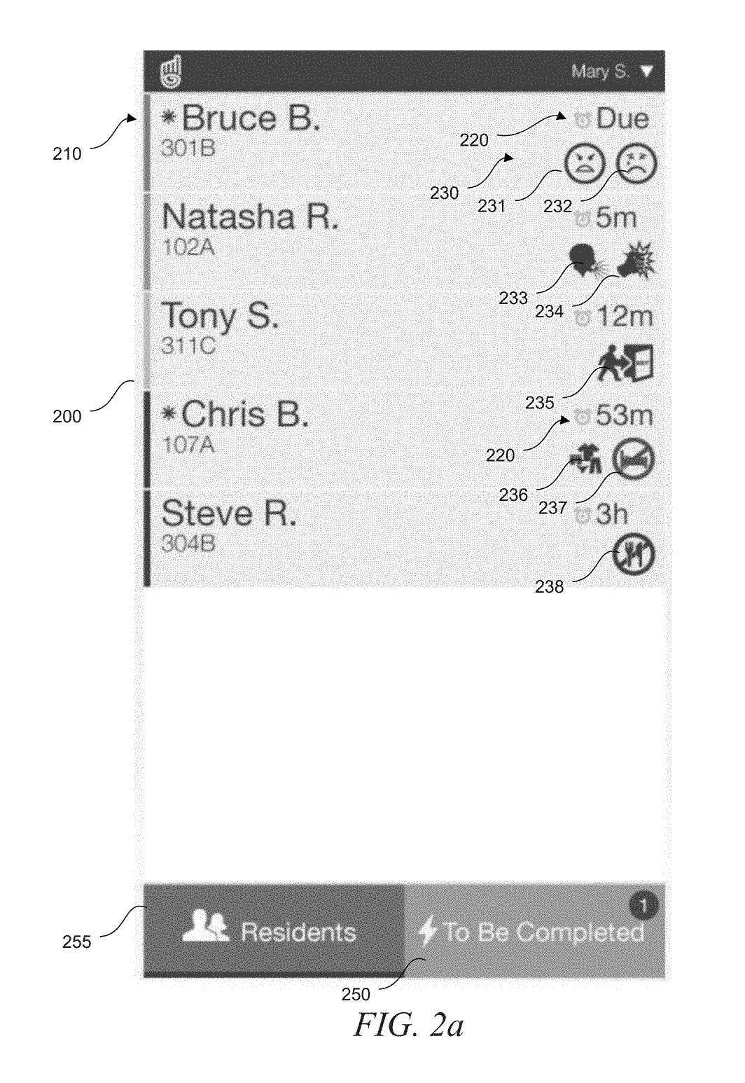

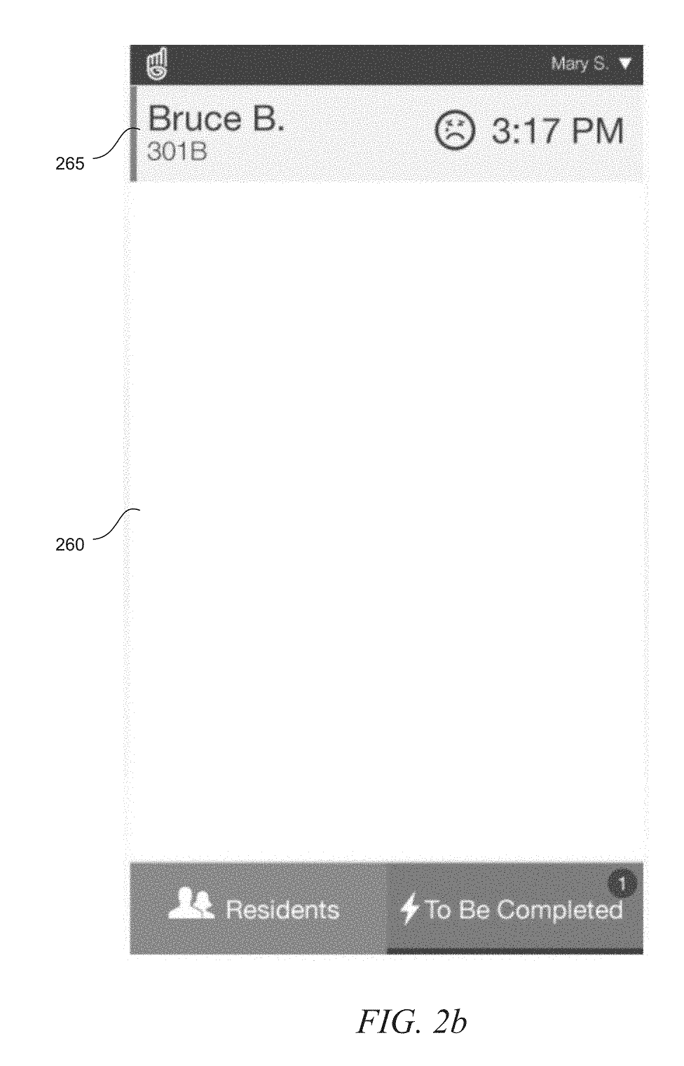

In many embodiments, the application operating at the user's mobile device 150 provides for data collection. FIG. 2a shows a typical interface page of the application. From this view, on the left side of the interface, the patent name and room number 210 are shown. The user may select a particular individual by actuating the button of the resident's name, typically via a touch interface. Additionally, timer 220 is shown on the right side of the interface. Timer 220 shows the time until a check on the resident is recommended. Interface 200 presents the resident list in a time based order in some configurations. Interface 200 presents those residents for which a check is due the soonest. In some confirmations, the order of presentation may be modified according to other orders that may be selected via a configuration interface. Additionally, when the time to check on a resident occurs, the application on the mobile device may actuate an alert, in the form of an audio indication, a vibrating indication, a light based indication, or other indicator.

Additionally, interface/menu 200 provides a graphically representation of a resident's typical behaviors. These representations of behaviors 230 are shown on the right side of the interface 200 associated with each resident. In the embodiment shown, various icons are shown such as icon 231 for an anger type behavior, icon 232 for a depression type behavior, icon 233 for a verbal aggression type behavior, icon 234 for a physical aggression type behavior, icon 235 for an exit seeking type behavior, icon 236 for a clothing removal type behavior, icon 237 for a sleeplessness type behavior, and icon 238 for a refusing to eat type behavior. Note that these icons and behaviors are only exemplary and a variety of icons and behaviors may be utilized. When a caregiver checks on a resident, these icons may be actuated in order to record the behavior of a resident, when the caregiver checks on the resident.

When an observation is due, an indication is provided in association with the “to be completed” button 250 (as shown by the number one). Additionally interface/menu 200 provides for residents button 255 that provides a listing of the residents, whether or not observation are due. When the “to be completed” button 250 is actuated the interface changes to show interface/menu 260 shown in FIG. 2b. Since only one patient/resident is due, only that resident 265 is shown.

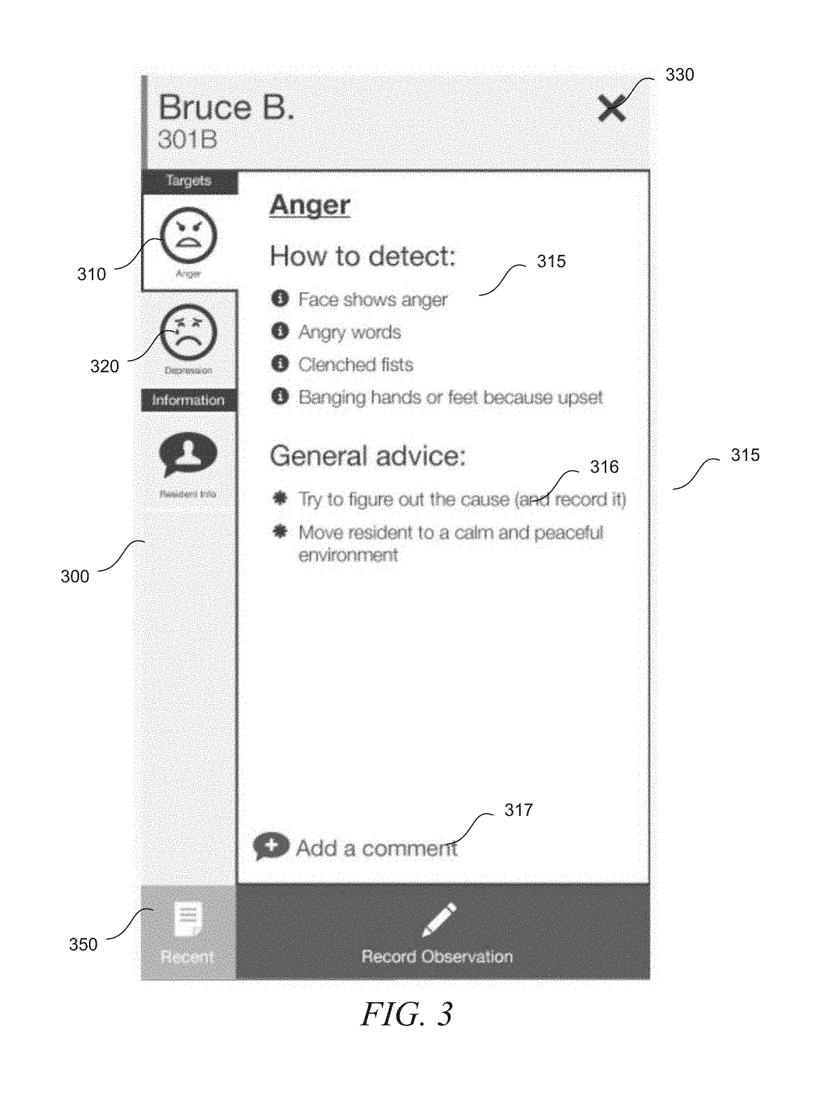

When a resident record is accessed via interface/menu 200, the application may provide basic information on the patient/resident. Such information is provided via interface/menu 300 shown in FIG. 3. This menu 300 provides multiple features. These features include descriptions of target behavior tabs 310, 320. Initially, tab 310 may be shown (or alternatively may be shown after actuation. Tab 310 displays a description 315 of a target behavior for the caregiver to observe and record. This description may be a generalized description of the behavior. Alternatively, it may be customized for the individual exhibiting the behavior. Additionally, as shown, tab 310 may display basic advice 316 for how to deal with the particular behavior. A comment button 317 may allow for the caregiver to provide for textual comments concerning how the behavior in question is displayed. Also of note is a cancel or x button 330, that allows the caregiver to return to the previous screen that provides a listing of residents and a recent button 350 that will be discussed below.

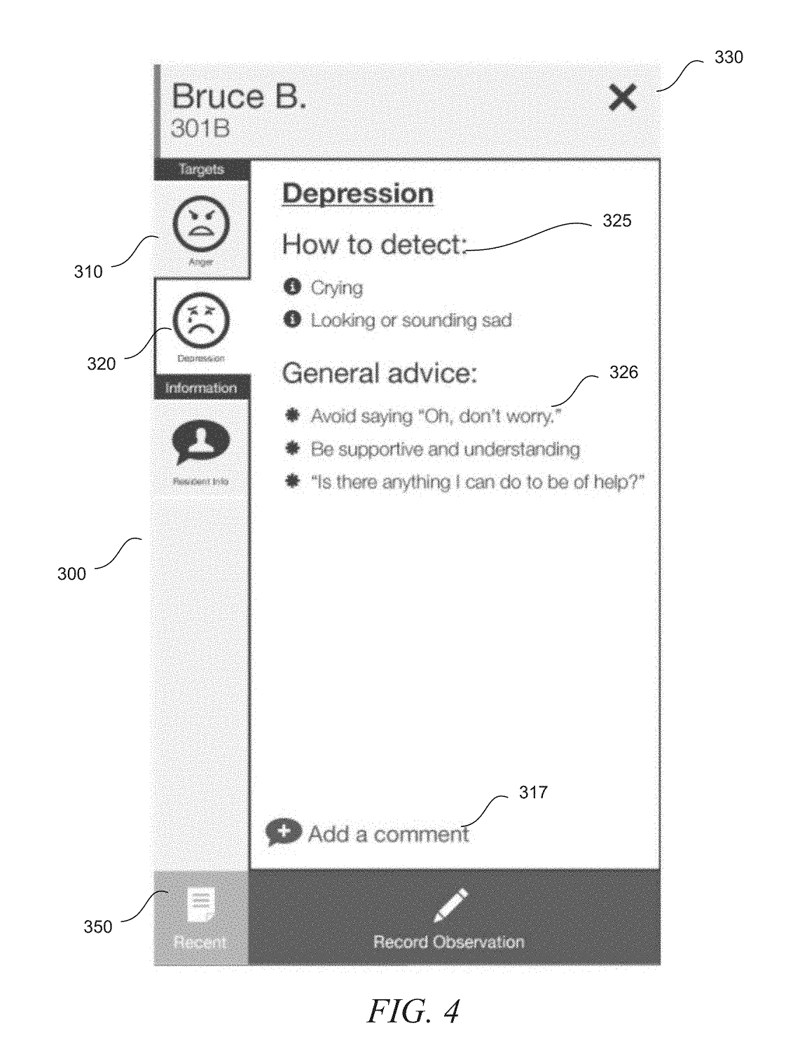

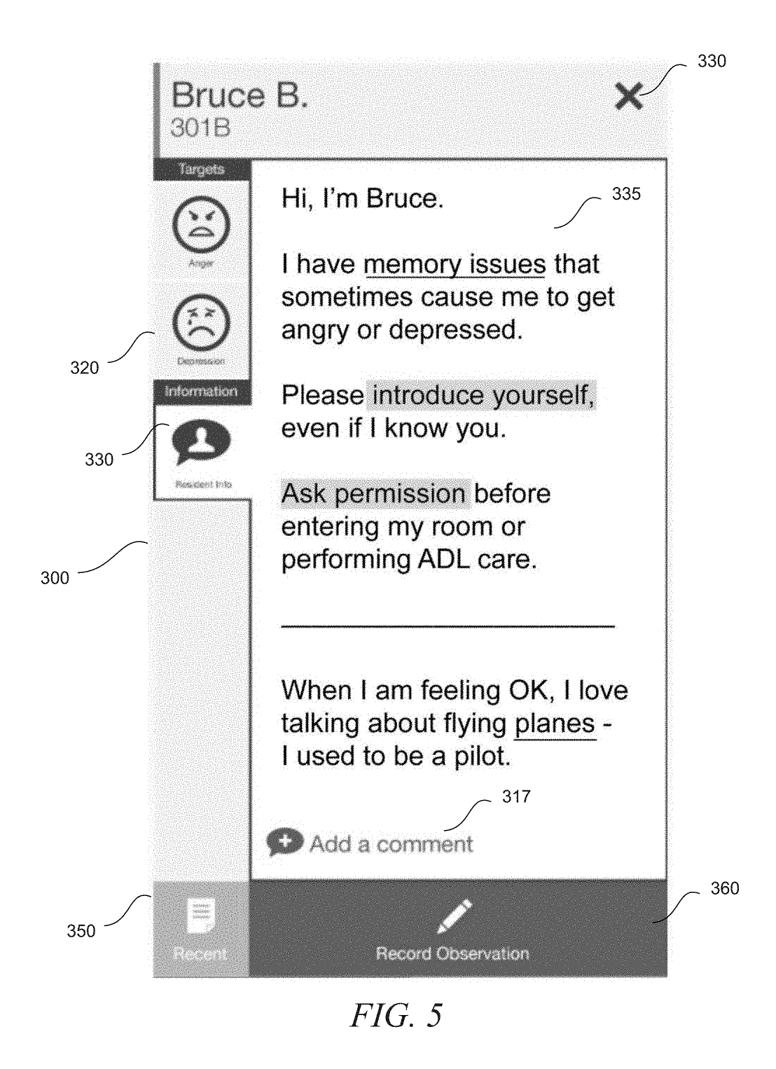

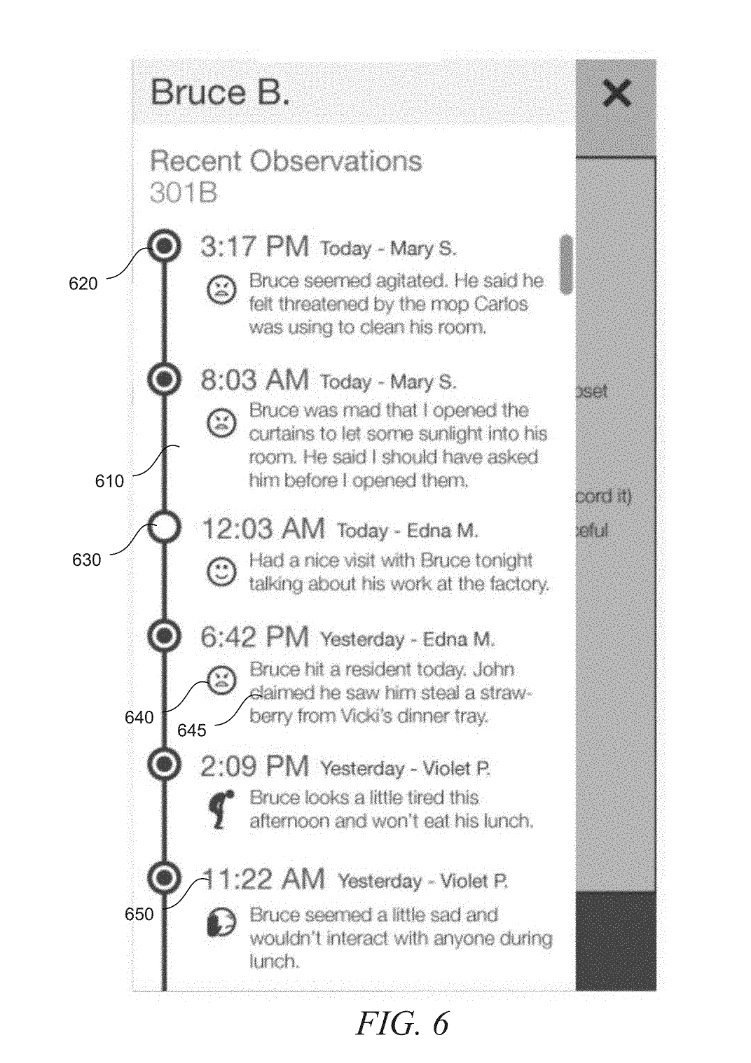

FIG. 4 shows a different view of menu 300. In FIG. 4, tab 320 for a second behavior has been actuated and additional description 325 of the target behavior and general advice 326 for dealing with the behavior may be displayed. FIG. 5 shows the view that is displayed when information tab 330 is actuated. Information tab 330 may provide basic information about special care instructions 335 for the resident. Once a caregiver is provided basic information about target behaviors and basic information concerning the resident, the user may record observations by actuating the record observation button 360. The recent observation button 350 brings up a scrolling overlay 610 displaying recent observations of the patient/resident. FIG. 6 shows one embodiment of scrolling overly 610. For quick reference, the scrolling overlay 610 includes negative incidents marked with a closed circle 620 and positive incidents marked with an open circle 630. Additionally, an icon 640 representative of the observed behavior is provided as well as a written description 645. Each entry also includes a listing 650 of the time of the observation and the observer.

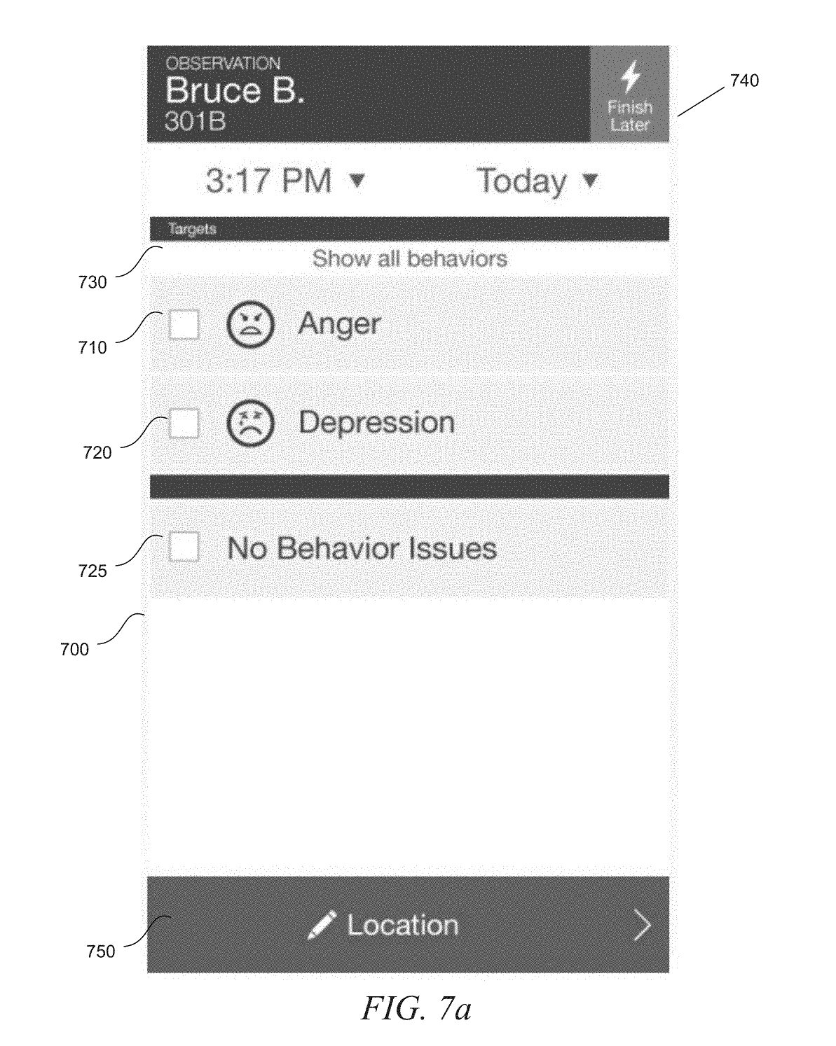

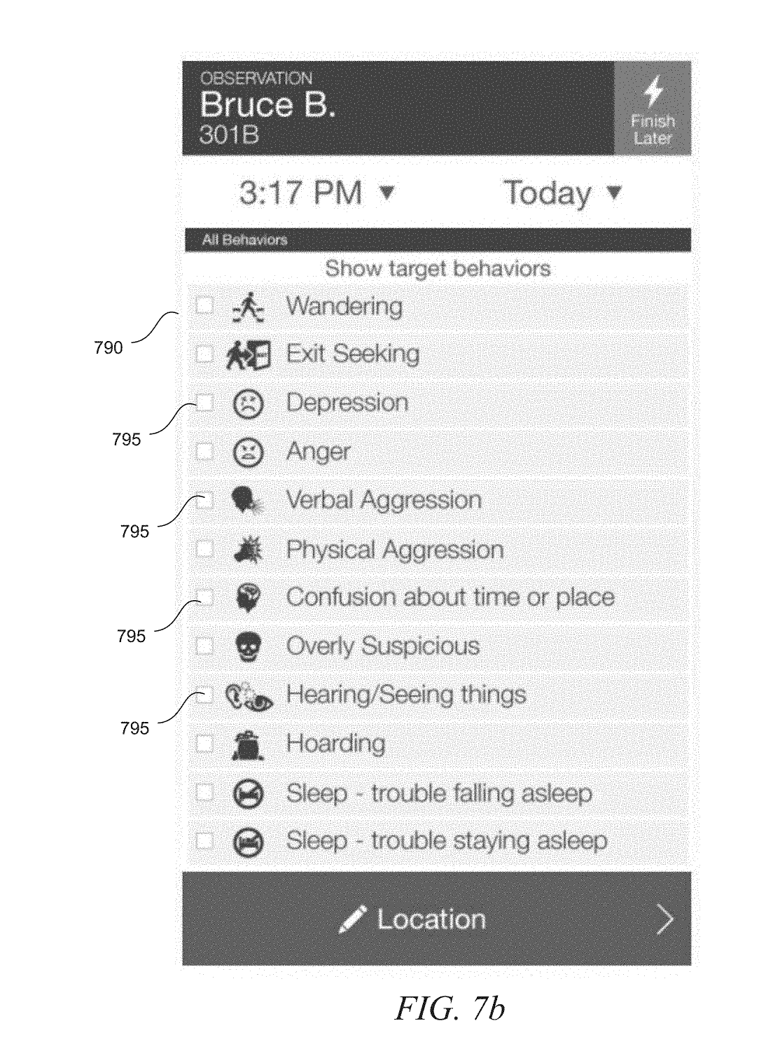

FIG. 7a shows another interface for the application resulting from the actuation of record observation button 360. Interface 700 shows a behavior interface screen providing for the selection of a behavior for a resident. As shown the user may select a behavior 710, 720, in this case anger or depression (button 725 is used to record no behavior issues). As shown, a check box type indicator is used, but this is purely exemplary. Additionally, if another behavior is exhibited, the user may select option 730. Option 730 provides additional behaviors, either by providing more options in interface 700 or by providing another interface. FIG. 7b shows an example of such a menu/interface 790 with additionally behaviorally option 795. Additionally, the caregiver may indicate that there are no behavior issues by actuating option 740. As mentioned above the interface is generally a touch interface, however other types of interfaces may be utilized. Interface 700 additionally provide a “finish later” button 740. In many situations, the user may not have time to enter observations due to other requirements of caregiving. In such a scenario, the user may actuate the “finish later” button 740. The system will then briefly cease reminding the caregiver to record observations until a later time. The functionality associated with the “finish later” button 740 may automatically set reminders at 15 minute intervals (or any other interval). A variety of different presets are available for reminders. Additionally shown on interface 700 is a location button 750. Button 750 provides for the entry of additional data concerning the behavioral state of the resident.

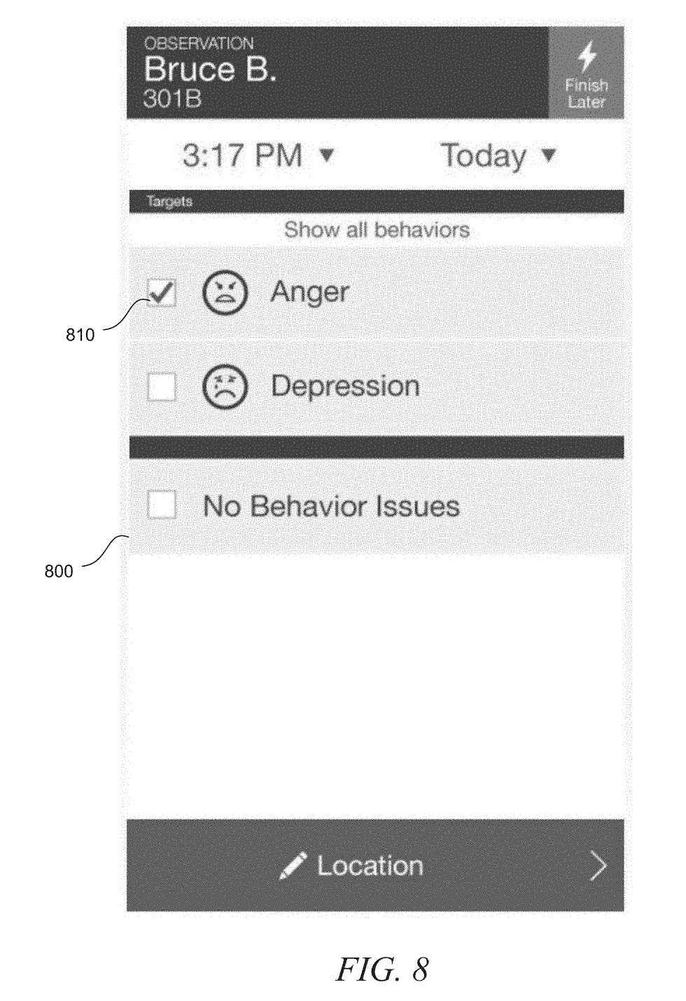

FIG. 8 shows an embodiment of an additional interface that provides for additional behaviors 810. Interface 800 shows the result of the user actuating section option 730 from interface 700.

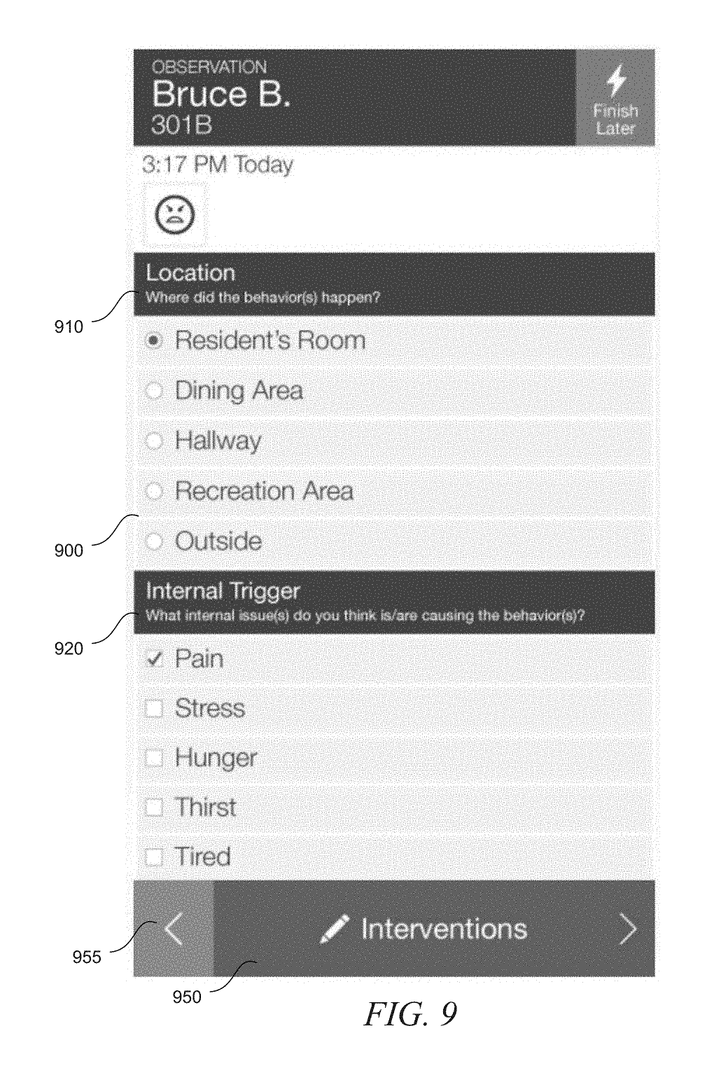

If button 750 is actuated by the user then interface 900 shown in FIG. 9 is accessed. In this interface 900, various options for the recording of data concerning the resident are offered including but not limited to the location menu 910 and the internal pain trigger menu 920. These menus generally provide options to the caregivers to record additional data concerning their behavior observations. These menus may be customized according to the usual locations observations will occur as well as the usual triggers for behaviors. The locations and triggers shown are purely exemplary. The provision of a preset menu provides for the rapid entry of data and facilitates the later analysis of the data. Once the information is entered into interface 900, button 950 may be actuated to access the next menu and interface. Also shown in this view is arrow 955 which allows the user to return to the previous screen.

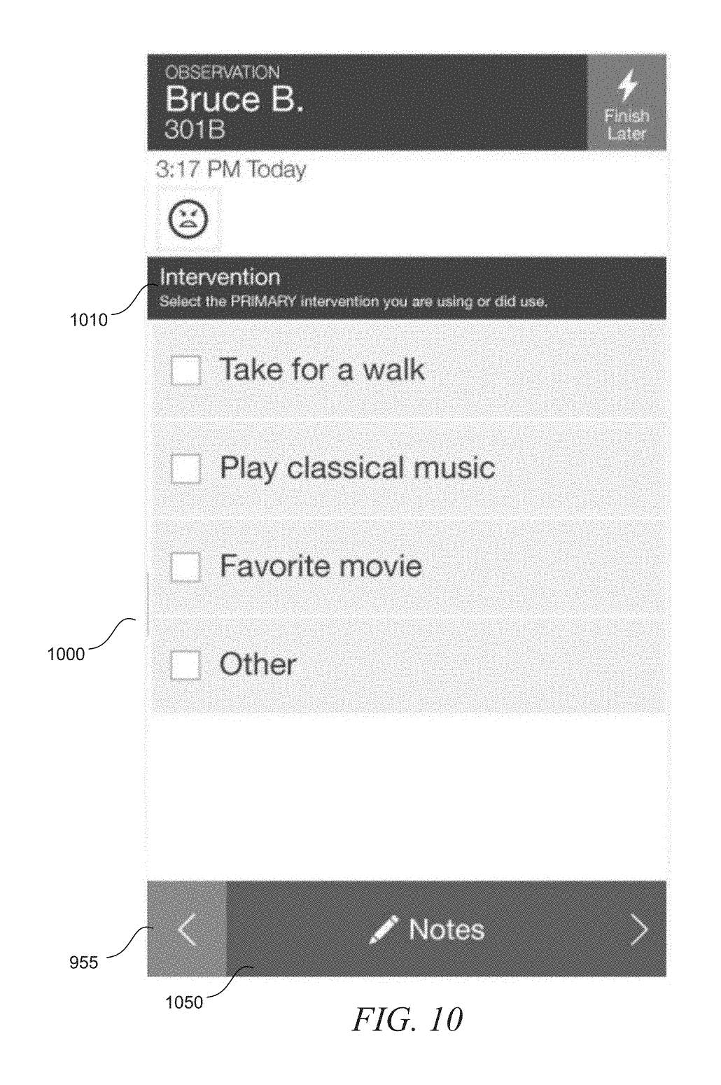

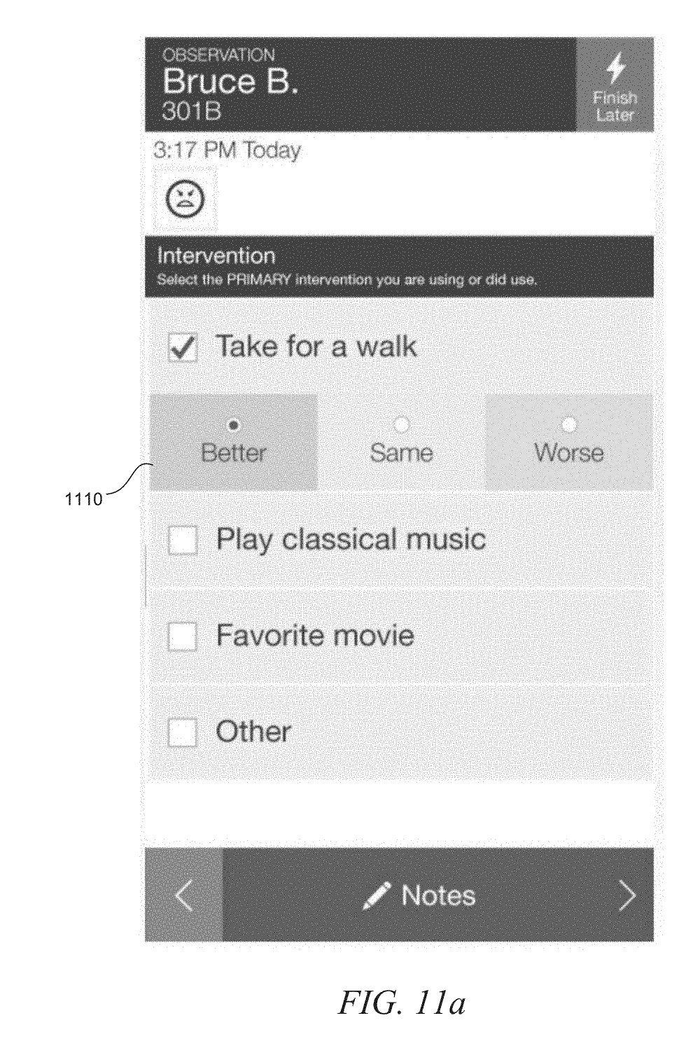

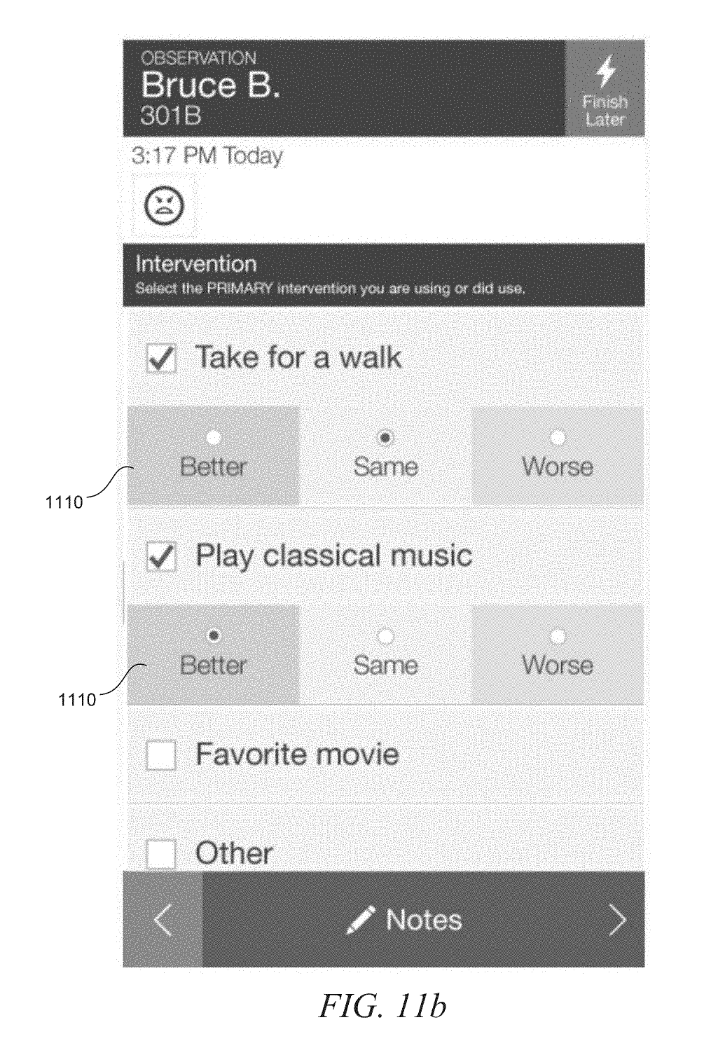

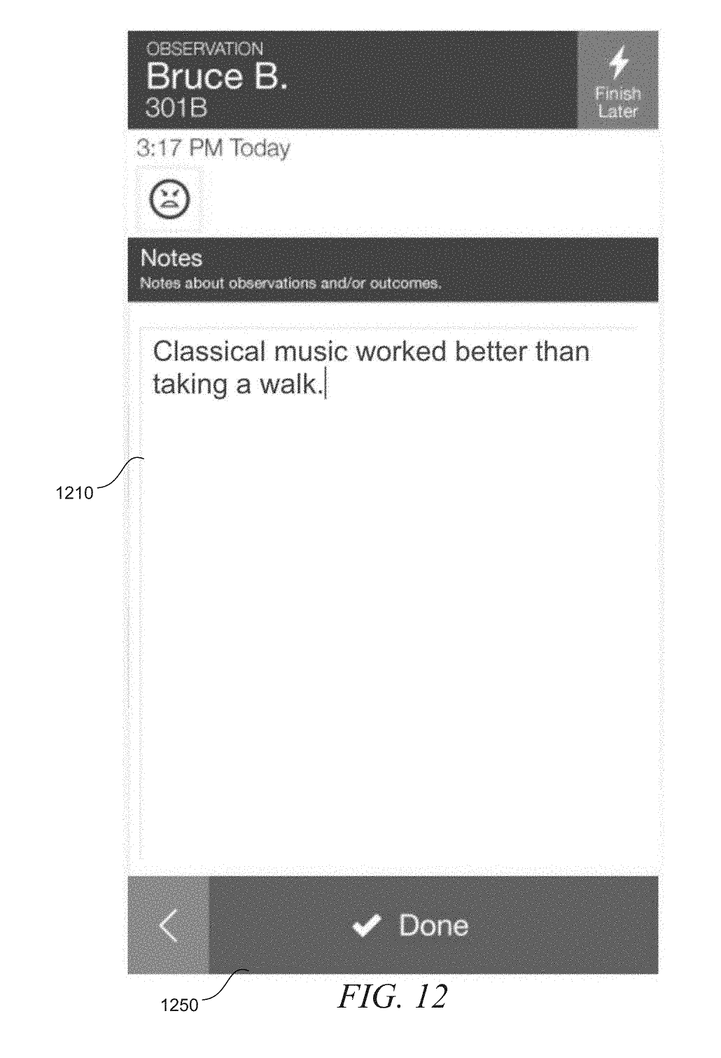

FIG. 10 shows possible interventions to provide to the patient/resident that may be selected via interface 1000. When there is a behavioral issue, interface 1000 presents possible interventions in menu 1010. The interventions provided may be customized according to the patent/resident and the caregiver administering the intervention. Once an intervention is recorded using menu 1010, the caregiver may actuate button 1050 in order to proceed to the next menu/interface. As shown in FIGS. 11a and 11b, in some scenarios when an intervention is selected, a submenu 1110 may be provided for the caregiver to indicate whether the applied treatment was effective. As shown, multiple options are available, however these are merely exemplary. Additionally, as shown in FIG. 12 interface/menu 1210 provides for a text box for the entry of textual notes concerning an intervention provided or other occurrences. Done button 1250 provides for the completion of the data entry.

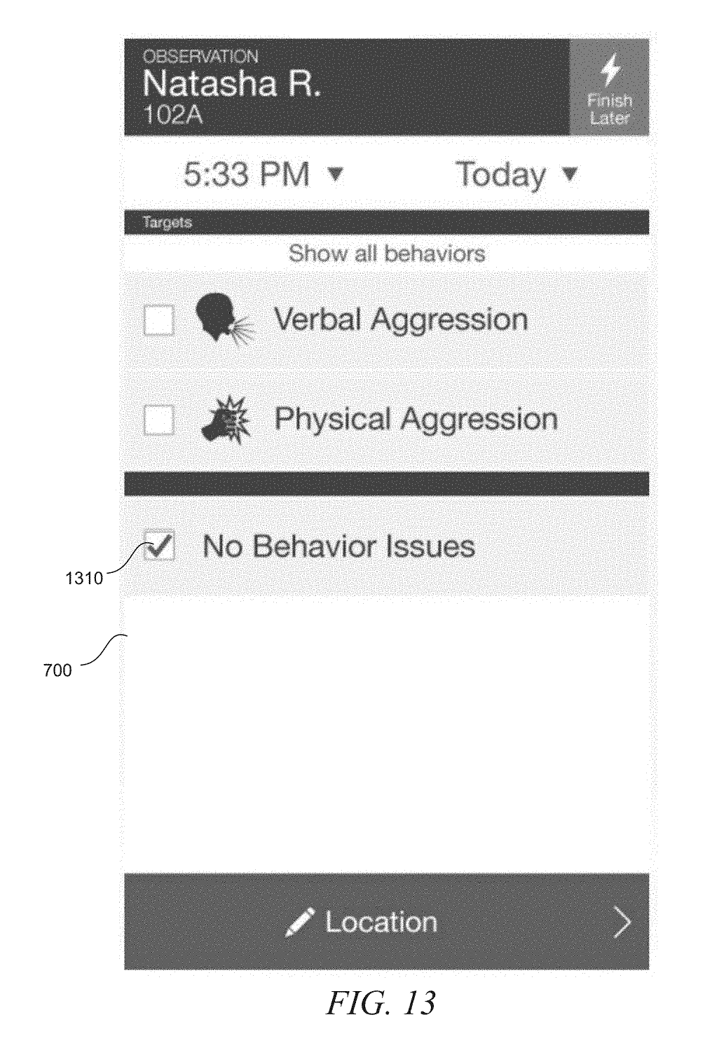

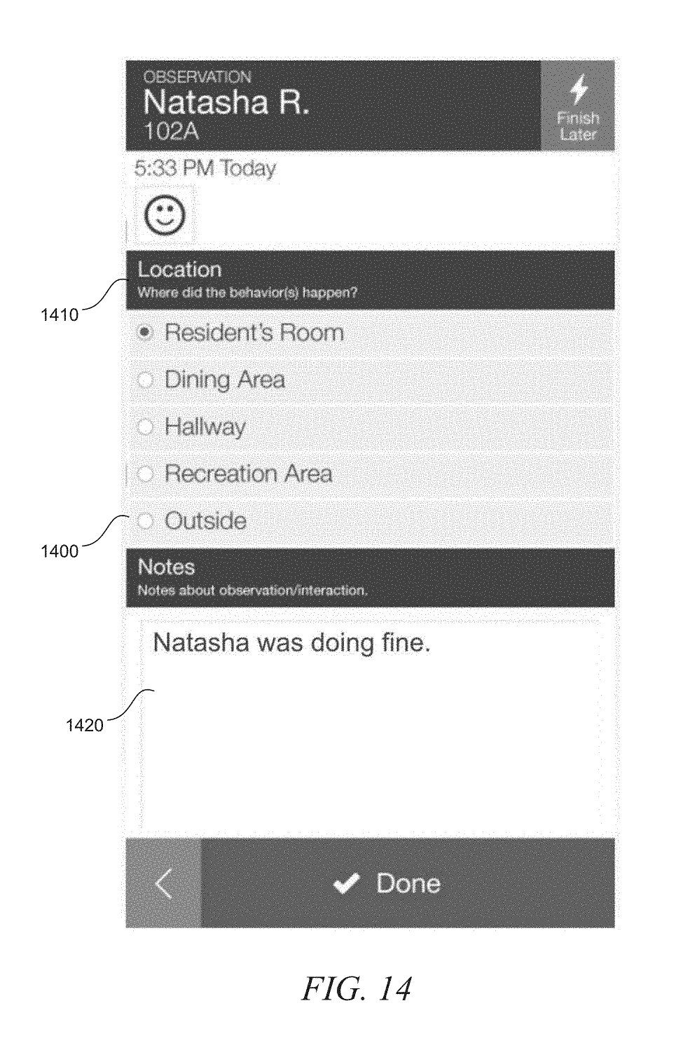

FIG. 13 shows an additional scenario for interface/menu 700, where the caregiver indicates no behavioral issues by actuating indicator/button 1310. In FIG. 14, the subsequent interface/menu 1400 is shown where the user may still be asked to enter the location 1410 of the observation and any notes 1420.

In many embodiments, if a caregiver is failing to recognize certain conditions in a patient/resident, in addition to providing basis information to recognize a condition through interface/menu 300, additional on the spot training may provide to a caregiver. This may be in the form of a video, written material, or merely a reminder that the caregiver may not be properly noting certain behaviors or alternatively may include other materials. This may be based on historical trends for particular caregivers and may incorporate temporal, situational, interrelation to the resident, or other factors.

FIGS. 2-14 generally describe an exemplary embodiment of the system for collecting data from caregivers concerning patient/resident behavior. Embodiments of systems include various features that make the system optimal. The system may collect a variety of types of data, including but not limited to:

Resident demographics (age, gender, etc. . . . )

Resident diagnosis, medications, health conditions

Location at time of recording

Observation schedule for the resident

Time of day, Day of Week

Sleep patterns for the resident

Time-series of resident behaviors

Time-series of staff behavior interventions

Time-series of staff data entry

Staff work schedules

Characteristics of the care facility

Analysis of these data points may provide for insights into the care facility and the care of residents. The rapid data analysis by the interface/menus provided facilitate the collection of this data.

First, the interfaces/menus allow for data to be collected quickly and easily, with minimal inconvenience and time for the caregiver. This is accomplished by presenting the caregiver with information concerning what behaviors are of interest. Additionally this is accomplished by presenting information on discerning those behaviors. Additionally, this is accomplished by providing for rapidly fillable forms, including in many configurations buttons that may be quickly pressed. Additionally, this is accomplished by having the forms and the buttons reflect the expected behaviors of the individual. The system may monitor and collect data on what disruptive behaviors are commonly observed and provide preset buttons for the recording of those behaviors. Additionally, when a new medicine or other treatment is administered, the preset behavior buttons may be adjusted to reflect expected negative behaviors resulting from such new medicine or other treatment.

Second, the system provides for reminders and automatic scheduling for the collection of data. The system automatically schedules and reminds the caregiver of when observations should be made based on various criteria. These criteria may include, but are not limited to, the schedule the resident is one, when medicine or treatment are administered, based on when previous behavioral events are observed, based on a fixed or variable period, based on the monitoring characteristics of the caregiver. In relation to the monitoring characteristics of the caregiver, the system may analyze data related to the observations of various caregivers. The system may identify that some caregivers fail to detect certain conditions/behaviors. In response, the system may increase the frequency of observation for that caregiver for the patient/resident that failure to properly observe is identified. The system provides for scheduling by delivering through the interface/menus of the app an ordered list of patients/residents. This list is automatically advanced or reordered according to environmental changes. Additionally, the application provided on the mobile device may provide visual indications, audio indications, or tactile indications (vibrations) that may remind the caregiver that an observation must be taken. As mentioned above, as needed the system provides a “finish later” function that will allow the caregiver to record observations at a later time and will accordingly remind the caregiver that completion is required.

Additionally, the system may provide for prioritized data gathering. In many embodiments, the system may prioritize the list presented to a caregiver according to the highest priority observations that are need. Note that the system may modify the prioritized list that not just a single caregiver sees and utilizes, but all caregivers in a facility. The prioritization may be based on various criteria, including those noted above, such as schedules, regular periodic intervals, the administration of a treatment, etc. Prioritization may be based on a weighted information gain of each missing data item, where the information gain is weighted by the expected impact on suggested interventions and predictions and inversely weighted by the effort needed to gather the data item.

The data recorded and analyzed by the system may be weighted based on the confidence the system has in the data collected. In some configurations, the data may be given more or less weight based on the predilections of the data collector (caregiver). Such a confidence weighted decision support analysis may be based on estimates of the reliability of the care staff's data entry at the time of recording as well. The system may note that in certain scenarios the caregiver is recording less observations, less detailed observations, or generally providing less quality data, and may de-emphasis data collected during these periods.

Insights from collections of certain populations may be applied to other populations. Decision support based on “best practices” extracted from patterns found across the population of similar residents, and tailored to the specific resident based on their individual data patterns. Since the system is collecting data concerning one resident, that data may be compared to other collections of data and based on similarities, the system may suggest certain interventions that were implemented for those having similar records.

For residents, caregivers typically create intervention plans. Since the system enables the collection of data concerning resident/patient activities, trends or graphs may be provided to caregivers in order to enable the production of intervention plans. Since this data may be presented in a way that accounts for combination of situational factors, and especially taking into account the care staff characteristics and the trends in both caregiver and resident behaviors. The provision of such detailed data will ease the analysis and production of plans by summarizing historical data trends and presenting potential changes that could optimize the intervention plan.

Additionally, the system may provide for iterative optimization of treatment/interventions (see FIG. 10). The system may suggest interventions in real-time. Each time an intervention is recorded as being successful, the intervention may be more likely to be suggested. Each time an intervention is recorded as being unsuccessful, it is less likely to be suggested by the system in the future. This may occur in a continual iterative process, with the interventions/treatments that are suggested being continually updated based on the data collected.

Additionally, based on historical data, the system may anticipate when more staff or less staff may be needed. The system, in some embodiments, may analyze past data to help supervisory and clinical staff predict and prioritize staffing needs for day of week, time of day, time of month, etc. so as to support scheduling and hiring decisions.

The system will also provide reports on the activities of caregivers. Based on comparing the data collection trends and intervention effectiveness trends of caregivers and comparing these trends to other caregivers, the system may identify exemplary caregivers and caregivers that need improvement. Therefore, supervisory and clinical staff may identify care staff who are especially effective (“role model staff”) and staff that are in need of training or additional guidance (“opportunity staff”) to guide staff recognition efforts as well as prioritize peer and expert training for under-performing staff. The performance of the staff will include measures of: effectiveness of care for mitigating resident behavior issues, timeliness and consistency of observations, appropriateness of interventions, and consistency and accuracy of data entry into iris.

Additionally, the system may provide persons outside the care facility (e.g. legally allowed physicians and family) to provide information relevant to behavior issues for the resident in a secure manner. This information is made available to the facility clinicians to help guide their tailoring of the resident's intervention plan. The clinician/supervisor may be any person, remote or on site, and may include medical doctors, health professionals, software administrators, and other trained or untrained individuals.

As previously indicated, the “finish later” function allows care staff in a single step to defer the completion of partially finished documentation and simultaneously add the completion task to a their work queue and linked notifications. This function is uniquely useful for point-of-care use systems because it allows the care staff to optimally manage their own time sensitive work-flow while ensuring that the automatic time-stamping generated by the documentation system is accurate to the time of care delivery.

In many embodiments, when a medication is administered to an resident, expected behavioral side effects or other side effects are automatically included in the target behavior tabs (see FIG. 3). Accordingly, the occurrence of these behaviors may be monitored and recorded in real-time. This allows clinicians to track behavioral changes that are related to medication type or dose changes. In addition, by linking to external data about medication side effects as well as observations captured by the system over the population of residents, the system will predict likely behavioral changes based on medication changes. The system will then alert clinicians and caregivers about these potential behaviors real-time with prioritization based on severity, estimated state of resident, and overall likelihoods of the behaviors. In some configurations, these alerts support adaptive scheduling, e.g. escalated observation frequency following the initiation of specific medications. The information gathered by the system will also help clinicians refine the state of the art knowledge of the behavioral changes associated with medications.

Embodiments of the systems and methods described herein address the problem of how to collect more reliable data in these types of care settings, and use data of various reliability to help caregivers make more optimal decisions, as well as help other caregivers to improve care over time. These systems may be implemented in the context of Long-term care (Skilled Nursing Facilities, Assisted Living Facilities, Intellectual and Developmental Disability Centers), where multiple caregivers (e.g., administrators, directors of nursing, physicians, psychologists, social workers, charge nurses, certified nursing assistants) may be involved with the care of any particular resident; Hospitals, where physicians, nurses, and medical aids may deliver care throughout the day for any particular resident; and Home-based care, where physicians, home care workers, and family members may be involved in care for an individual.

In some embodiments, the system provides for enhanced command and control (C2) options, whereby the system and a supervisor utilizing the system may update protocols according to changes of status of various variables in the system, such as the staff, the condition of the patients, the time of day, and other variables, including those discussed herein.

A clinician or a supervisor may act like a wired platoon commander and getting high cadence “sensor feeds” from the caregivers and then guiding the caregivers as to what actions to take, including interventions, re-orienting the sensors (gathering specific data), or consuming cued training materials. The benefit is better decision support for the clinician, more comprehensive training for the caregivers, more “scalability” for clinicians re: covering more patients/facilities more effectively, and better care for patients. For instance, a supervisor may determine based on the data presented by the system, that it is unlikely that the proper observations are being made concerning patient emotional states. Therefore, the supervisor may deploy immediate training reminders to all caregivers, via their mobile devices. Further, the supervisor may change variables in the system to affect staff behavior in the desired direction, such as which behaviors are listed as focus behaviors for any resident, what the timing schedule is for any resident, and how staff are rewarded for different actions.

Such real-time or near real-time C2, allows a remote clinician to monitor the data being entered by caregivers in real-time and near-real time reports (hourly vs. sporadically entered text reports that they currently review on a bi-weekly or monthly basis). The clinician or supervisor can then specifically indicate that caregivers should look for a given behavior, decrease the observation schedule, specify that a given caregiver should be the primary contact for a patient, log sleep/eating/hygiene/social activity/lucidity, etc. The clinician can also cue up training for specific caregivers on how to perform the necessary observations. In some alternatives, the clinician advice is automated based on data-driven machine learning algorithms that try to mimic the clinician decision process based on the data gathered. In some embodiments, rules are layered with the clinician reports and clinician to the caregivers, to provide guidance to help focus the efforts of the caregivers on the highest information gain, risk mitigation and reimbursement likelihood.

In some embodiments, the emphasis is on an “on-call” clinician on or off site having real-time “situational awareness” provided by the system. In some embodiments, the clinician may have a constantly updating map of the facility with icons indicating location and characteristics of each patient and caregiver. The patient characteristics would include time to scheduled observation, observation priority, last behavior, last sleeping/awake observation, next medication time, next ADL (activities of daily living) need, acute behavior risk, etc. The caregiver characteristics may include experience, gender, last observation, pending queued training, observation frequency, etc. The clinician would then be able to instant message or alert the caregiver to prioritize observing a given patient with given priorities for which data to log.

In many embodiments, parts of the system are provided in devices including microprocessors. Various embodiments of the systems and methods described herein may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form such as, but not limited to, source code, compiled code, interpreted code, executable code, static code, dynamic code, and the like. Such a computer-readable medium may include any tangible non-transitory medium for storing information in a form readable by one or more computers such as, but not limited to, read only memory (ROM); random access memory (RAM); magnetic disk storage media; optical storage media; a flash memory, etc.

Embodiments of the systems and methods described herein may be implemented in a variety of systems including, but not limited to, smartphones, tablets, laptops, and combinations of computing devices and cloud computing resources. For instance, portions of the operations may occur in one device, and other operations may occur at a remote location, such as a remote server or servers. For instance, the collection of the data may occur at a smartphone, and the data analysis may occur at a server or in a cloud computing resource. Any single computing device or combination of computing devices may execute the methods described.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

We claim:

1. A computer-implemented method for monitoring resident behavior, health, and treatments received, the method being executed by one or more processors and comprising:
providing a prioritized list of residents to be observed on a mobile computing device;
receiving from a user at the mobile computing device, a selection of a resident of the list of residents;
displaying at the mobile computing device, information related to a behavior of interest of the resident;
receiving from the user an input concerning behavior of the resident at the mobile computing device; and
displaying a proposed intervention at the mobile computing device.

2. The method of claim 1, wherein the proposed intervention is received at the mobile computing device from a remote server.

3. The method of claim 2, wherein the input concerning the behavior of the resident is sent to the remote server and the proposed intervention is based on the input from the user concerning the behavior of the resident.

4. The method of claim 3, wherein the proposed intervention is also based on data concerning effectiveness of previous interventions.

5. The method of claim 1, wherein the prioritized list of residents is provided to the mobile computing device from a remote server, and the remote server prioritizes the prioritized list according to weighted information gain of the behavior of interest of the resident as compared to other information that is collectable from other residents.

6. The method of claim 1, further comprising:
receiving an input concerning the success of intervention administered at the mobile computing device; and
transmitting the input concerning the success of intervention to the remote server.

7. The method of claim 1, further comprising:
prior to receiving the input concerning behavior of the resident, receiving a “finish later” indication from the user at the mobile device; and
altering the user at a later time of the need to complete the input concerning behavior of the resident.

8. The method of claim 1, further comprising determining at a remote server the information related to the behavior of interest of the resident to be displayed, based on previous data concerning behaviors of interest; and
transmitting the behavior of interest of the resident to be displayed to the mobile computing device.

9. The method of claim 1, wherein the information related to the behavior of interest, includes displaying training information on how to recognize the behavior of interest.

10. The method of claim 1, further comprising displaying basic resident characteristics for the resident.

11. The method of claim 1, wherein the proposed intervention is based on best practices information, determined via analyzing data related to populations of similar residents across different populations.

12. The method of claim 11, wherein the best practices information is tailored based on specific characteristics and patterns of the resident.

13. The method of claim 1, wherein the prioritized list of residents is provided to the mobile computing device from a remote server, and the remote server prioritizes the prioritized list according to weighted information gain of a missing data item, where the weighted information gain is weighted by an expected impact on suggested interventions and predictions and inversely weighted by an effort needed to gather the missing data item.

14. The method of claim 1, further comprising:
providing, to a supervisor, facility information concerning residents that are included in the list of residents and staff;
receiving a request to reorder the prioritized list from the supervisor, based on the facility information; and
reordering the prioritized list based on the request.

15. The method of claim 1, further comprising:
providing, to a supervisor, facility information concerning residents that are included in the list of residents and staff;
receiving a request to change the behavior of interest from the supervisor, based on the facility information; and
changing the behavior of interest based on the request.

16. The method of claim 1, further comprising:
providing, to a supervisor, facility information concerning residents that are included in the list of residents and staff;
receiving a request to provide training information to the user from the supervisor, based on the facility information; and
providing the training information to the user at the mobile computing device.

17. The method of claim 16, wherein the training information is selected from a group consisting of a reminder via text message, a reminder via instant message, and a reminder via the GUI of an application running on the mobile device.

18. The method of claim 14, wherein the facility information includes time to scheduled observations of the residents, observation priority of the residents, last behavior of the residents, last sleeping/awake observation of the residents, next medication time for the residents, next ADL (activities of daily living) need for the residents, acute behavior risk for the residents.

19. The method of claim 14, wherein the supervisor is selected from the group consisting of a human, a computer implemented algorithm, and a human assisted by analysis related to the facility information.

20. The method of claim 1, further comprising modifying the behavior of interest based on changes in medication.

21. A non-transitory computer-readable storage device coupled to one or more processors and having instructions stored thereon which, when executed by the one or more processors, cause the one or more processors to perform operations for monitoring resident behavior, health, and treatments received, the operations comprising:
providing a prioritized list of residents to be observed on a mobile computing device;
receiving from a user at the mobile computing device, a selection of a resident of the list of residents;
displaying at the mobile computing device, information related to a behavior of interest of the resident;
receiving from the user an input concerning behavior of the resident at the mobile computing device; and
displaying a proposed intervention at the mobile computing device.

22. A system, comprising:
one or more processors; and
a computer-readable storage medium in communication with the one or more processors and having instructions stored thereon which, when executed by the one or more processors, cause the one or more processors to perform operations for monitoring resident behavior, health, and treatments received, the operations comprising:
providing a prioritized list of residents to be observed on a mobile computing device;
receiving from a user at the mobile computing device, a selection of a resident of the list of residents;
displaying at the mobile computing device, information related to a behavior of interest of the resident;
receiving from the user an input concerning behavior of the resident at the mobile computing device; and
displaying a proposed intervention at the mobile computing device.

23. The system of claim 22, wherein the proposed intervention is received at the mobile computing device from a remote server.

24. The system of claim 23, wherein the input concerning the behavior of the resident is sent to the remote server and the proposed intervention is based on the input from the user concerning the behavior of the resident.

25. The system of claim 24, wherein the proposed intervention is based on best practices information, determined via analyzing data related to populations of similar residents across different populations.

26. The system of claim 25, wherein the best practices information is tailored based on specific patterns of the resident.

27. The system of claim 24, wherein the input concerning behavior of the resident at the mobile computing device is weighted according to an estimate of reliability of the input of the user, based on previous data related to observation trends of the user.

28. The system of claim 24, wherein the proposed intervention is also based on data concerning effectiveness of previous interventions.

29. The system of claim 22, wherein the prioritized list of residents is provided to the mobile computing device from a remote server, and the remote server prioritizes the prioritized list according to weighted information gain of the behavior of interest of the resident as compared to other information that is collectable from other residents.

30. The system of claim 22, wherein the operations further comprise:
receiving an input concerning the success of intervention administered at the mobile computing device; and
transmitting the input concerning the success of intervention to the remote server.

31. The system of claim 22, wherein the operations further comprise:
prior to receiving the input concerning behavior of the resident, receiving a “finish later” indication from the user at the mobile device; and
altering the user at a later time of the need to complete the input concerning behavior of the resident.

32. The system of claim 22, wherein the operations further comprise:
determining at a remote server the information related to the behavior of interest of the resident to be displayed, based on previous data concerning behaviors of interest; and
transmitting the behavior of interest of the resident to be displayed to the mobile computing device.

33. The system of claim 22, wherein the information related to the behavior of interest, includes tips on how to recognize the behavior of interest.

34. The system of claim 22, wherein the operations further comprise: displaying basic resident characteristics for the resident.

35. The system of claim 22, wherein the operations further comprise:
providing, to a supervisor, facility information concerning residents that are included in the list of residents and staff;
receiving a request to reorder the prioritized list from the supervisor, based on the facility information; and
reordering the prioritized list based on the request.

36. The system of claim 22, wherein the operations further comprise:
providing, to a supervisor, facility information concerning residents that are included in the list of residents and staff;
receiving a request to change the behavior of interest from the supervisor, based on the facility information; and
changing the behavior of interest based on the request.

37. The system of claim 22, wherein the operations further comprise:
providing, to a supervisor, facility information concerning residents that are included in the list of residents and staff;
receiving a request to provide training information to the user from the supervisor, based on the facility information; and
providing the training information to the user at the mobile computing device.

38. The system of claim 37, wherein the training information is selected from a group consisting of a reminder via text message, a reminder via instant message, and a reminder via the GUI of an application running on the mobile device.

39. The system of claim 35, wherein the facility information includes time to scheduled observations of the residents, observation priority of the residents, last behavior of the residents, last sleeping/awake observation of the residents, next medication time for the residents, next ADL (activities of daily living) need for the residents, acute behavior risk for the residents.

40. The system of claim 35, wherein the supervisor is selected from the group consisting of a human, a computer implemented algorithm, and a human assisted by analysis related to the facility information.

41. The system of claim 22, wherein the operations further comprise: modifying the behavior of interest based on changes in medication.
